(19) United States
(12) Patent Application Publication
(10) Pub. No.: US 2014/0118328 A1
(43) Pub. Date: May 1, 2014

(54) PIXEL DRIVING CIRCUIT OF AN ACTIVE-MATRIX ORGANIC LIGHT-EMITTING DIODE AND A METHOD OF DRIVING THE SAME

(71) Applicant: InnoLux Corporation, Miao-Li County (TW)

(72) Inventors: Hong-Ru GUO, Miao-Li County (TW); Ming-Chun TSENG, Miao-Li County (TW); Ching-Chieh TSENG, Miao-Li County (TW)

(73) Assignee: InnoLux Corporation, Miao-Li County (TW)

(21) Appl. No.: 14/044,934

(22) Filed: Oct. 3, 2013

(30) Foreign Application Priority Data
Oct. 25, 2012 (TW) 101139489

(51) Int. Cl. G09G 3/32

(52) U.S. Cl. CPC G09G 3/3258
USPC 345/212; 345/76

(57) ABSTRACT

This invention is related to a pixel driving circuit and a method of driving an active matrix OLED (AMOLED) that is driven by N-type transistors. The pixel driving circuit is configured with five thin film transistors and two capacitors for solving the shifted threshold voltage induced by attenuation of the N-type transistors, the rising cross voltage induced by a long working period of the OLED, and the IR-drop issue. The invention further improves the display quality of the OLED display unit by modifying the display uniformity.

### BACKGROUND OF THE INVENTION

1. Field of the Invention

The present invention relates to a pixel driving circuit and a method of the same, more particularly to a pixel driving circuit and a driving method of an active matrix organic light-emitting diode (AMOLED) that is cooperatively driven by N-type transistors.

2. Description of Related Art

Currently, the organic light-emitting diode (OLED) has a great potential for being applied to the field of display technology. The OLED display unit may be categorized by different driving modes into passive matrix OLED (PMOLED) and active matrix OLED (AMOLED). Each pixel of the driving circuit of AMOLED is provided with a capacitor for data storage thereby each pixel may be kept in an emitting state. Therefore, the power consumption of the AMOLED is less than that of the PMOLED. Furthermore, because the driving mode of the AMOLED is suitable for being applied to the display unit with large size and high resolution, the AMOLED is considered one of the major areas for future development.

The thin-film transistor (TFT) in the AMOLED may be categorized by different backplane process into N-type and P-type transistors. FIGS. 1A and 1B show respectively conventional pixel driving circuit of an AMOLED implemented by N-type and P-type transistors. FIGS. 1A and 1B show pixel driving circuits of AMOLED conventionally implemented by two TFTs combined with a capacitor (2T1C). As shown in FIG. 1A, when a scan line SCAN detects a pixel driving circuit 900A, a data line DATA would transmit a corresponding data voltage to a drain terminal D of a TFT 940A and the data voltage may be stored in a capacitor 920A. At the same time, another TFT 910A is subsequently operated in saturation region so that an electric current IA passing through a OLED 930A may be governed according to an equation IA=K(V_{GS}−V_{T})², in which K=1/2(μn*Cₒₓ)(W/L), μn is electron mobility, Cₒₓ is oxide capacitance, W/L is a width to length ratio of a gate terminal of the TFT 910A, V_{GS} is a voltage level between the gate and source terminals G, S of the TFT 910A, V_{T} is a threshold voltage of the TFT 910A. The TFT 910A is in active region when V_{GS} is greater than V_{T} of the TFT 910A so that the OLED 930A emits constantly according to the data voltage. FIG. 1B shows another conventional pixel driving circuit 900B driving an OLED 930B to emit in a similar way with 900A.

It can be known from the above that the brightness of OLEDs 930A, 930B may be determined by electric current passing through OLEDs 930A, 930B, respectively. The pixel driving circuit of the AMOLED configured with N-type transistors may still face the following drawbacks:
(1) Threshold voltage offset of an N-type transistor: this is due to mismatch in the production process of TFT or degradation induced by prolonged operation, this can lead to uneven display quality of the AMOLED.
(2) IR-drop: FIG. 2 shows an AMOLED configured of pixel driving circuits. As shown in FIG. 2, as a first voltage line 950 extends longer, inner resistance ΔR of the first voltage line 950 is greater and generates a voltage level (i.e., driving current I_{IN}×inner resistance ΔR) so that a first voltage V_{IN} may gradually degrade according to a relation defined by V_{IN}−I_{IN}×ΔR (i.e., V_{IN} gradually degrades due to increased ΔR as resulting from being farther from the first voltage line 950), and further results in gradual decrease of the current generated by N-type transistor driven by AMOLED, as the driving line 950 extends longer. Even more, with bigger panel size, the described impact would become more apparent, and ultimately cause uneven panel brightness. As such, IR-drop is a critical issue that demands no lesser attention in consideration of designing large-scale panels.
(3) Rise of the voltage difference for voltage increment across the OLED: due to material aging, voltage difference for voltage increment across the OLED would gradually increase and the illumination efficiency would decrease when the OLED is subject to prolonged operation. The voltage difference for voltage increment across the OLED may influence the voltage level between the gate and source terminals of the N-type transistor, and directly influence the current passing through the OLED, therefore undesirable display issue may follow.

Therefore, it is desirable to provide an improved pixel driving circuit of an AMOLED and a method for realizing it. The invention is configured with N-type transistors for driving the OLED and further configured with TFTs and capacitors to overcome the drawbacks as described above.

### SUMMARY OF THE INVENTION

In consideration of the known arts, a pixel driving circuit of an AMOLED using a N-type transistor would face problems such as threshold voltage offset in the N-type transistor, IR-drop, and rise of the voltage difference for voltage increment across OLED. The present invention presents a solution to resolve the above three issues by integrating multiple thin film transistors with an AMOLED pixel driving circuit composed of capacitors. By design of the present invention, the current passing through the N-type transistor that is for driving the OLED would remain constant and impervious to attenuation for all times. The current would also remain independent regardless of increase in voltage difference for voltage increment across the OLED. Furthermore, the voltage across the source terminal and the drain terminal of the N-type transistor that is for driving the OLED would not be subject to change as resulting from influence of threshold voltage of the transistor, driving voltage of the AMOLED pixel driving circuit, and ground voltage. The above may eventually trickle down to resolve poor display performance as resulting from IR-drop.

In order to achieve the above object, the present invention provides a pixel driving circuit for an active-matrix organic light-emitting diode (AMOLED). The pixel driving circuit includes a driving switch, an organic light-emitting diode (OLED), a voltage compensation switch, a storage capacitor, a data input switch, a reset unit, and a precharge unit. The driving switch has a first node and is adapted to receive the first voltage from the power supply unit. The OLED has a second node and a third node that is adapted to receive the second voltage from the power supply unit. The voltage compensation switch is electrically connected between the driving switch and the second node, and is capable of receiving a compensation signal for enabling the voltage compensation switch to perform a compensation on a voltage level between the first and second nodes to equal a threshold voltage of the driving switch. The storage capacitor is electrically connected between the first node and second node. The data input switch is electrically connected to the driving gate and a data signal and is capable of transmitting data signal to the storage capacitor based on a scan signal. The reset unit is electrically connected to the first node and a reference reset voltage and is capable of resetting the voltage for the driving gate based on a reset signal. The reset unit may be enabled by a reset signal so as to perform a reset action for modulating a voltage level on the first node to equal the reference voltage. The precharge unit is electrically connected to the second node and a charging voltage and is capable of receiving a precharge voltage. The precharge unit may be enabled by a precharge signal to perform a precharge action for modulating a voltage level on the second node to equal the precharge voltage. When the pixel driving circuit is disposed in a precharging state, the reset unit would receive the reset signal and the unit that is desired to be charged would receive the precharge signal; when the pixel driving circuit is disposed in a modulating state, the reset unit would receive the reset signal and the voltage compensation switch would receive the compensation signal; when the pixel driving circuit is in a data input state, the data input switch would receive the scan signal; when the pixel driving circuit is in a light emitting state, the voltage compensation switch would receive a compensation signal.

The pixel driving circuit may work sequentially in an order of a precharge state, a compensation state, a data input state and a light emitting state in cycles.

The driving switch, voltage compensation switch, and data input switch may be a N-type transistor based switch. The driving switch may comprise a driving drain and a driving source. The voltage compensation switch may comprise a compensation gate, a compensation drain, and a compensation source. The data input switch may comprise an input gate, an input drain, and an input source. The driving drain is connected to the first voltage, the driving gate is connected to a source, the driving source is connected to the compensation drain, the input gate is connected to the scan signal, the input drain is connected to the data signal, the compensation gate is connected to a compensation signal, and the compensation source is connected to the second node.

Also, the reset unit of the present invention, as well as the precharge unit may be a transistor switch.

The present invention further comprises a compensation capacitor, which connects the driving circuit and the above mentioned second node.

Another object of the present invention is to provide a method of driving a pixel driving circuit of an AMOLED implemented by a pixel driving circuit that includes a driving switch having a driving gate, an OLED having a second node and a third node, a voltage compensation switch electrically connected between the driving switch and the second node, a storage capacitor electrically connected between the first and second nodes, a data input switch electrically connected to the first node and capable of receiving a data signal, a reset unit electrically connected to the first node and capable of receiving a reference reset voltage, and a precharge unit electrically connected to the second node and capable of receiving a precharge voltage. The method includes the steps of: (A) the reset unit receiving a reset signal and the precharge unit receiving a precharge signal when the pixel driving circuit is in a precharge state; (B) the reset unit receiving a reset signal and the voltage compensation switch receiving a compensation signal when the pixel driving circuit is in a compensation state; (C) the data input switch receiving a scan signal when the pixel driving circuit is in a data input state; and (D) the voltage compensation switch receiving the compensation signal when the pixel driving circuit is in an light emitting state.

The above summary and the following detailed description are provided for the purpose of illustration only, in order to better explain for the basis of the patent claims of the invention. Other objects, advantages, and novel features of the invention will become more apparent from the following detailed description when taken in conjunction with the accompanying drawings.

### BRIEF DESCRIPTION OF THE DRAWINGS

FIG. 1A is a schematic diagram of a conventional pixel driving circuit of an AMOLED driven by N-type transistors;

FIG. 1B is a schematic diagram of a conventional pixel driving circuit of an AMOLED driven by P-type transistors;

FIG. 2 is a schematic diagram of a conventional driving circuit of the AMOLED configured by multiple pixel driving circuits;

FIG. 3 is a schematic diagram of a preferred embodiment of a driving circuit of an AMOLED according to this invention;

FIG. 4 is a schematic diagram of the preferred embodiment of a pixel driving circuit according to this invention;

FIG. 5 is a timing diagram of the pixel driving circuit in a precharge state, a compensation state, a data input state and a light emitting state according to this invention;

FIG. 6 is a flow chart of the preferred embodiment of the pixel driving circuit according to this invention;

FIG. 7A is a first schematic diagram of the preferred embodiment of the pixel driving circuit in the precharge state;

FIG. 7B is a second schematic diagram of the preferred embodiment of the pixel driving circuit in the compensation state;

FIG. 7C is a third schematic diagram of the preferred embodiment of the pixel driving circuit in the data input state; and

FIG. 7D is a fourth schematic diagram of the preferred embodiment of the pixel driving circuit in the light emitting state.

### DETAILED DESCRIPTION OF THE PREFERRED EMBODIMENT

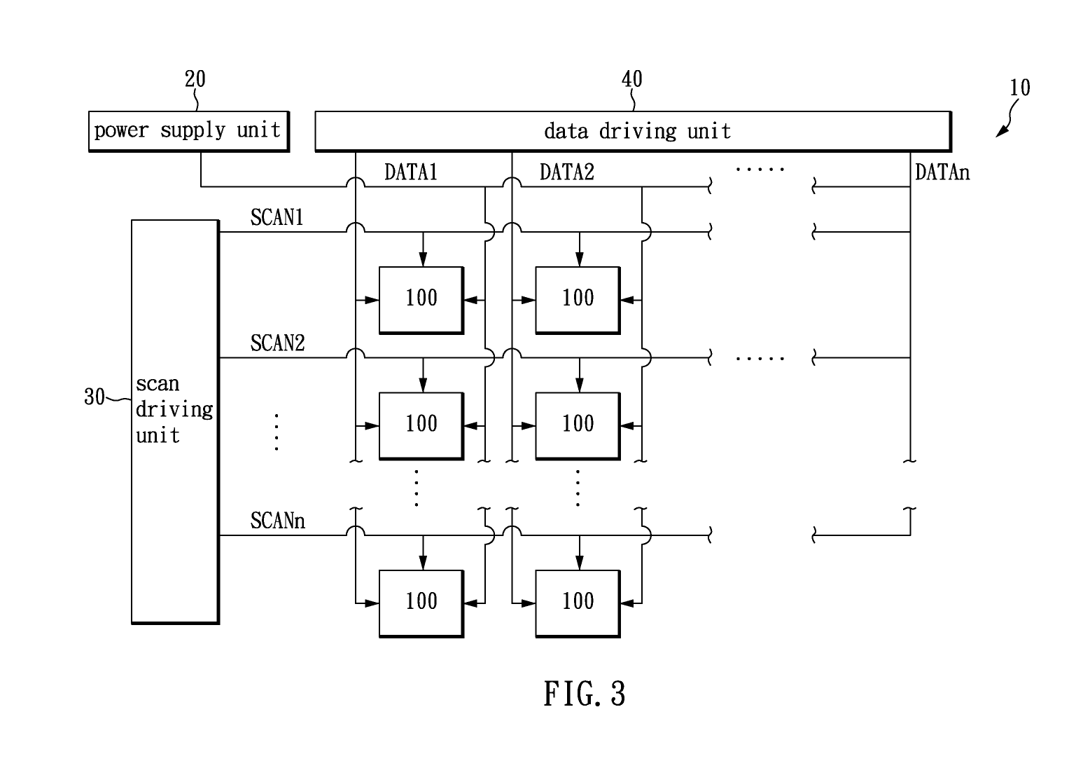

As shown in FIG. 3, an apparatus 10 for driving an active-matrix organic light-emitting diode (AMOLED) includes a power supply unit 20, a scan driving unit 30, a data driving unit 40, and multiple pixel driving circuits 100. The scan driving unit 30 is electrically connected to multiple scan lines SCAN1˜SCANn that are configured in parallel. The data driving unit 40 is electrically connected to multiple data lines DATA1˜DATAn that are configured in parallel and insulatedly intersect with the scan lines SCAN1˜SCANn. The pixel driving circuits 100 are configured in arrays to drive scanning lines and data lines. The data driving unit 40 is electrically connected to pixel driving circuits 100 arranged in each column direction through data lines DATA1˜DATAn. The scan driving unit 30 is electrically connected to pixel driving circuits 100 arranged in each row direction through scan lines SCAN1˜SCANn. The power supply unit 20 provides electric power to each pixel driving circuit 100 so that the driving circuit 10 of the AMOLED may enable an OLED in each pixel driving circuit 100 to emit.

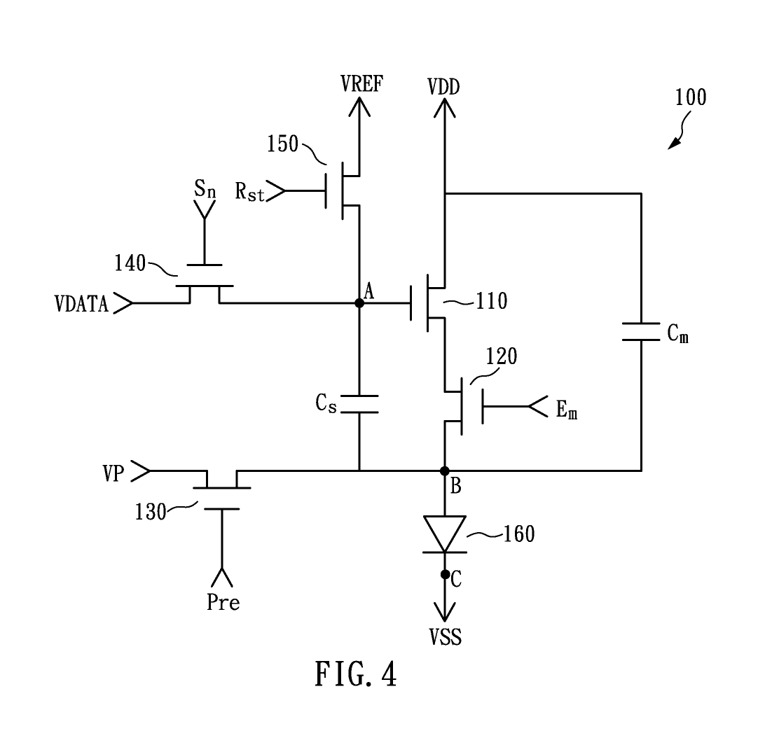

As shown in FIG. 4, a pixel driving circuit 100 includes a driving switch 110, a voltage compensation switch 120, a precharge unit 130, a data input switch 140, a reset unit 150, an OLED 160, a capacitor Cs and a compensation capacitor Cm. In this embodiment, the driving switch 110 has a first node A (i.e. the driving gate of the driving switch 110), a driving drain and a driving source. The voltage compensation switch 120 has a compensation gate, a compensation drain and a compensation source. The data input switch 140 has a data input gate, a data input drain and a data input source. The driving drain is capable of receiving a first voltage VDD provided by the power supply unit 20 for driving the pixel driving circuit 100. The driving source is electrically connected to the compensation drain. The first node A is electrically connected to the data input source. In the present embodiment, the driving switch 110, voltage compensation switch 120, and data input switch 140 are all N-type transistor switches.

The OLED 160 has a second node B and a third node. The second node B is electrically connected to the compensation source of the voltage compensation switch 120 and the third node is capable of receiving a second voltage VSS. In this embodiment, the voltage level of the second voltage VSS is lower than the first voltage VDD and the second voltage VSS may be a ground voltage of 0V.

The voltage compensation switch 120 is electrically connected between the driving switch 110 and the second node B. The compensation gate of the voltage compensation switch 120 is capable of receiving a compensation signal Em for enabling the voltage compensation switch 120 to perform a compensation on a voltage difference between the first node A and the second node B. The storage capacitor Cs is electrically connected between the first node A and the second node B. The compensation capacitor is electrically connected between the driving drain and the second node B.

The data input switch 140 is electrically connected between the first node A and one of the data lines DATA1. The data input drain is electrically connected to said data line DATA1 and capable of receiving a data signal VDATA. The data input gate is electrically connected to one of the scan lines SCAN1 and capable of receiving a scan signal Sn and transmitting the data signal VDATA to the capacitor Cs according the scan signal Sn.

The reset unit 150 is electrically connected to the first node A and capable of receiving a reference reset voltage VREF. The reset unit 150 unit may be enabled by a reset signal Rst so as to perform a reset action for modulating a voltage level on the first node A to equal the reference voltage VREF. The reset unit 150 is a N-type transistor switch and has a reset drain for receiving the reference voltage VREF, a reset gate for receiving the reset signal Rst, and a reset source electrically connected to the first node A of the driving switch 110.

The precharge unit 130 is electrically connected to the second node B of the OLED 160 and capable of receiving a precharge voltage VP. The precharge unit 130 may be enabled by a precharge signal Pre so as to perform a precharge action on the second node B to modulate the voltage level on the second node B to equal the precharge voltage VP. The precharge unit 130 has a precharge drain for receiving the precharge voltage VP, a precharge gate for receiving the precharge signal Pre, and a precharge source electrically connected to the second node B of the OLED 160.

As shown in FIG. 5, the pixel driving circuit 100 of the AMOLED works in a sequential order of a precharge state, a compensation state, a data input state and a light emitting state in cycles. The voltage compensation switch 120, the precharge unit 130, the data input switch 140 and the reset unit 150 work in a close state “0” and an open state “1” and can be represented as an expression of (120, 130, 140, 150), with each bit specified as a 0 or 1. For example, in reference to FIG. 5, if the pixel driving circuit 100 works in the precharge state, the expression would be (120, 130, 140, 150)=(0, 1, 0, 1), that means the voltage compensation switch 120 and the data input switch work in close states, and the precharge unit 130 and the reset unit 150 work in open states. Then, the operation of the precharge state, the compensation state, the data input state and the light emitting state may be represented as (120, 130, 140, 150) with each bit being 0 or 1 in the following paragraph.

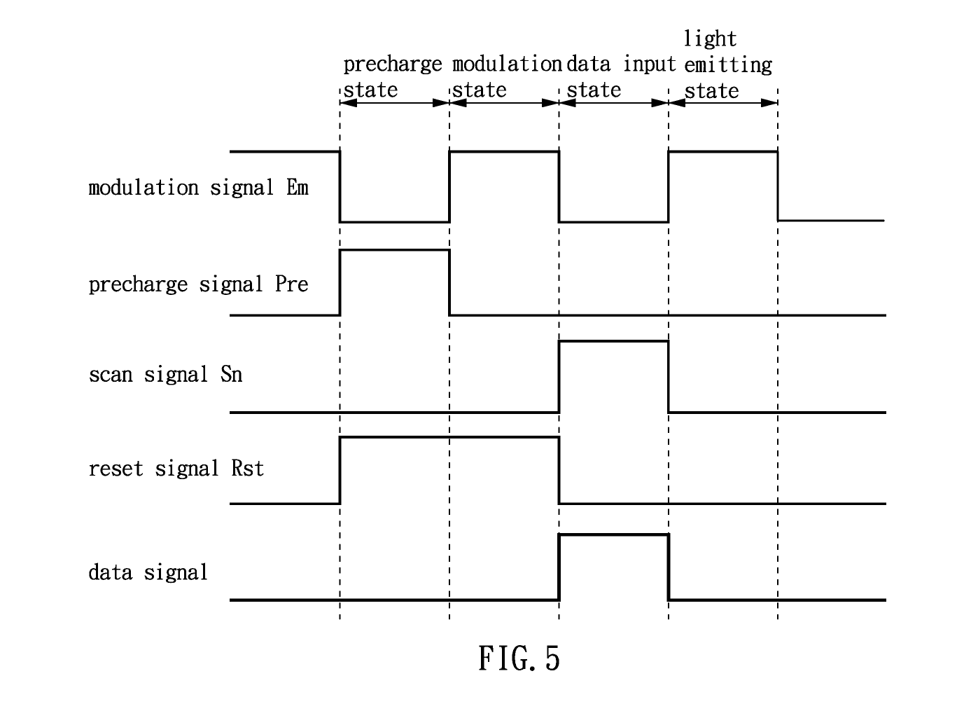

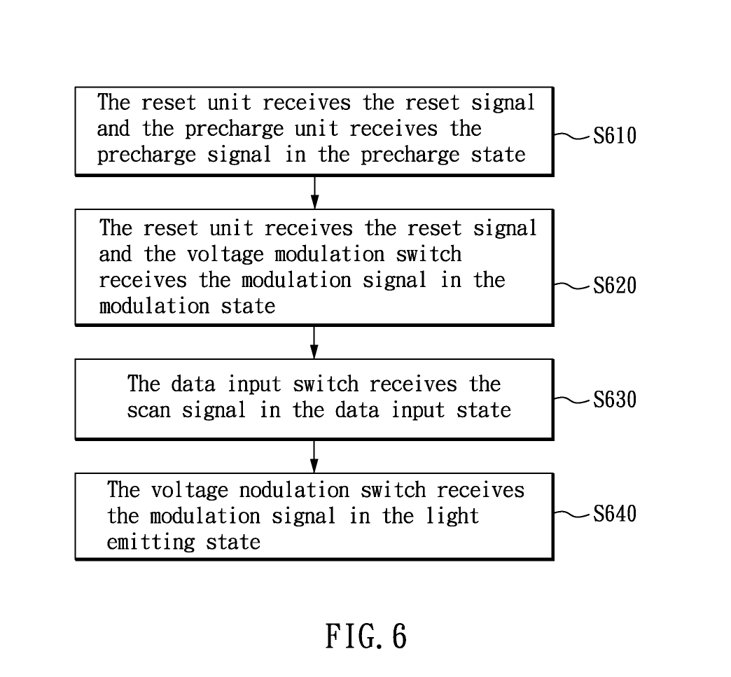

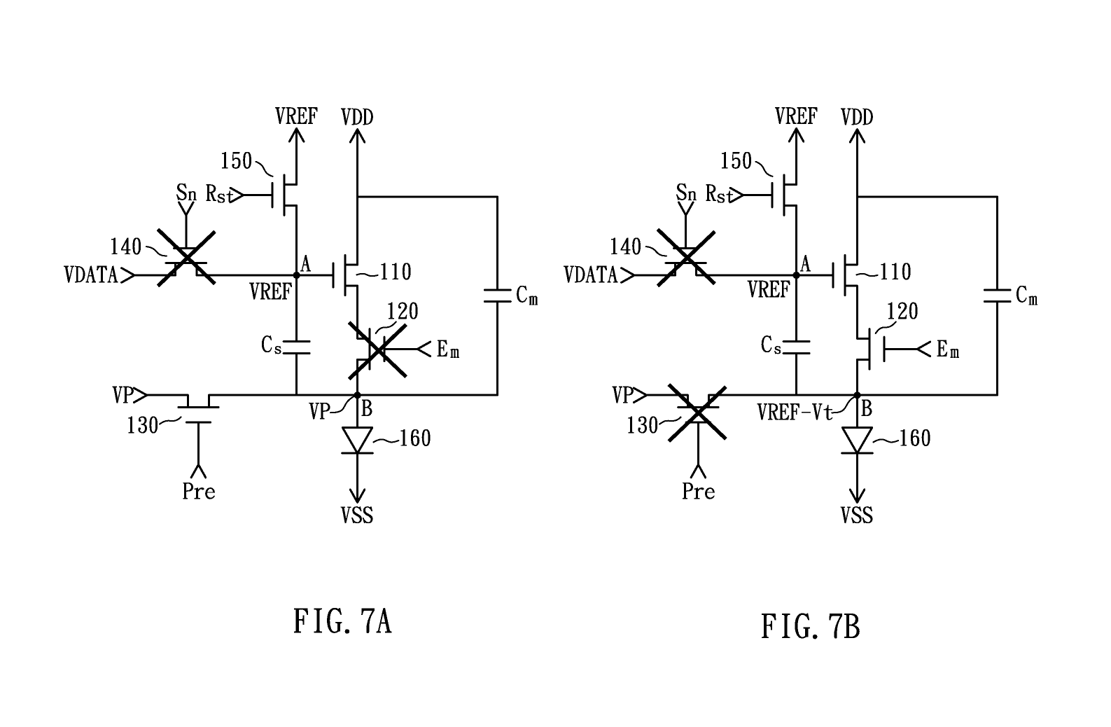

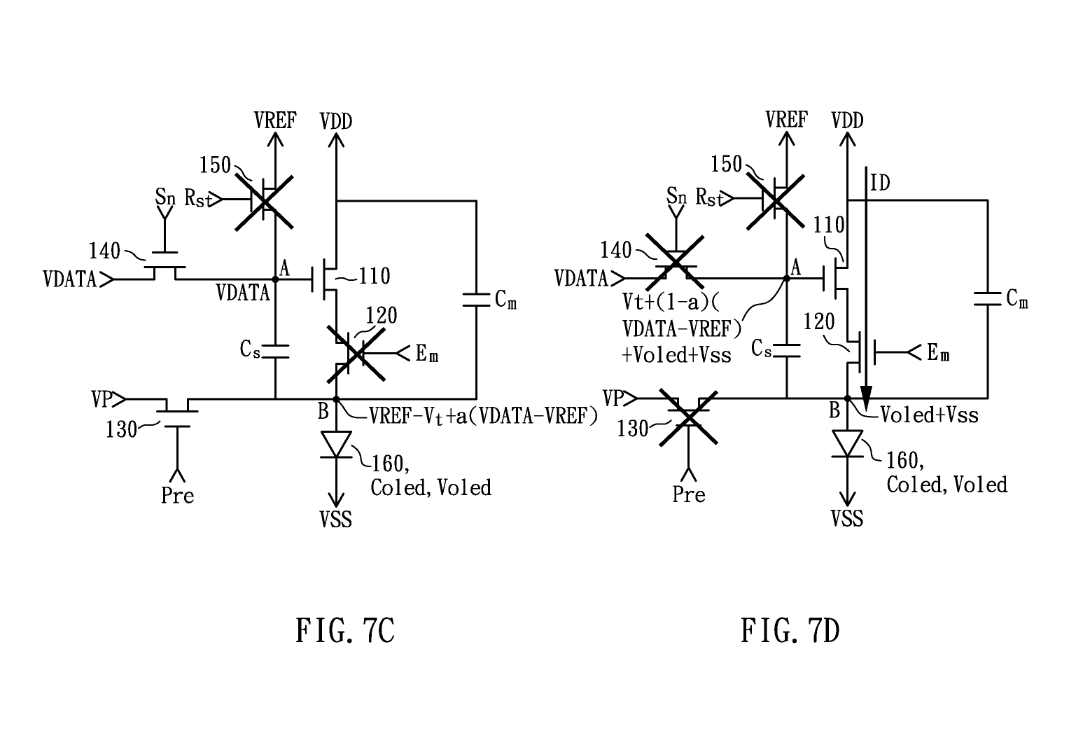

As shown in FIGS. 6 and 7A, when the pixel driving circuit 100 works in the precharge state, the expression (120, 130, 140, 150) is equal to (0, 1, 0, 1). Therein, the reset unit 150 receives the reset signal Rst and the precharge unit 130 receives the precharge signal Pre. The reference reset voltage VREF is transmitted to the first node A through the reset unit 150, so as to raise the voltage level on the second node B to be equal to the precharge voltage VP (step S610).

As shown in FIGS. 6 and 7B, when the pixel driving circuit 100 works in the compensation state, the expression (120, 130, 140, 150) is equal to (1, 0, 0, 1). Therein, the reset unit 150 receives the reset signal Rst and the voltage compensation switch 120 receives the compensation signal Em. The reference voltage VREF is transmitted to the first node A through the reset unit 150 for keeping the voltage level on the first node A equal to the reference voltage VREF. Subsequently, the voltage level on the second node B is modulated to approach the first voltage VDD until the voltage level on the second node B reaches a level of reference voltage VREF minus the threshold voltage Vt of the driving switch 110 (not shown), wherein the voltage level on the second node B is equal to VREF−Vt. Thus the driving switch 110 stops modulating the voltage level on the second node B so that the voltage level between the first node A and the first node B is equal to the threshold voltage Vt of the driving switch 110. Therefore, the object of modulating the threshold voltage Vt of the driving switch 110 may be achieved (step S620).

As shown in FIGS. 6 and 7C, when the pixel driving circuit 100 works in the data input state, the expression (120, 130, 140, 150) is equal to (0, 0, 1, 0). Therein the data input switch 140 receives the scan signal Sn. The data signal VDATA is transmitted to the first node A through the data input switch and stored into the storage capacitor Cs. Then, the voltage level on the second node B is modulated to equal an equation: VREF−Vt+a(VDATA−VREF); in which “a” is the ration of the storage capacitor to the paralleled storage capacitor Cs, the compensation capacitor Cm and the inner capacitor Coled of the OLED 160, i.e. “a”=Cs/(Cs+Cm+Coled) (step S630).

As shown in FIGS. 6 and 7D, when the pixel driving circuit 100 works in the light emitting state, the expression (120, 130, 140, 150) is equal to (1, 0, 0, 0). Therein, the voltage compensation switch 120 receives the compensation signal Em so that the voltage level on the second node B is modulated to equal an equation: Voled+VSS; in which Voled is turn-on voltage of the OLED 160. The voltage level on the first node A is modulated to equal an equation: Vt+(1−a)(VDATA−VREF)+Voled+VSS; in which “a”=Cs/(Cs+Cm+Coled). The cross voltage between the first node A and the second node B is equal to an equation: Vt+(1−a)(VDATA−VREF). Subsequently, the driving switch 110 works in the saturation region so that the driving current ID passing through the OLED 160 is kept to equal an equation: ID=K[(1−a)(VDATA−VREF)]²; in which K=1/2(μn*Cₒₓ)(W/L), μn is electron mobility, Cₒₓ is oxide capacitance, W/L is the width to length ratio of the driving gate of the driving switch 110, and “a” is Cs/(Cs+Cm+Coled). Thereby, the OLED 160 continuously emits according to the data signal VDATA until the scan line SCAN1 scans the pixel driving circuit 100 once again (step S640).

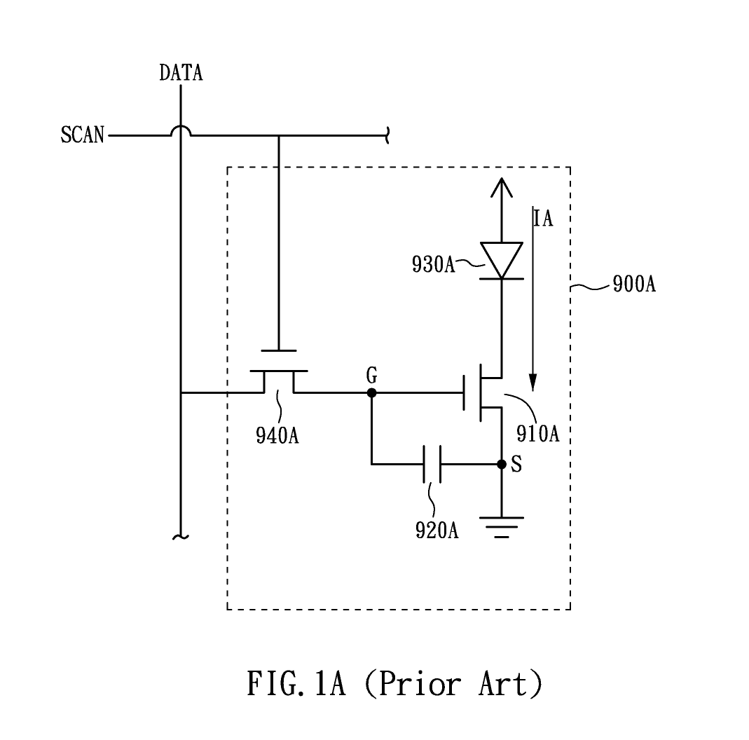

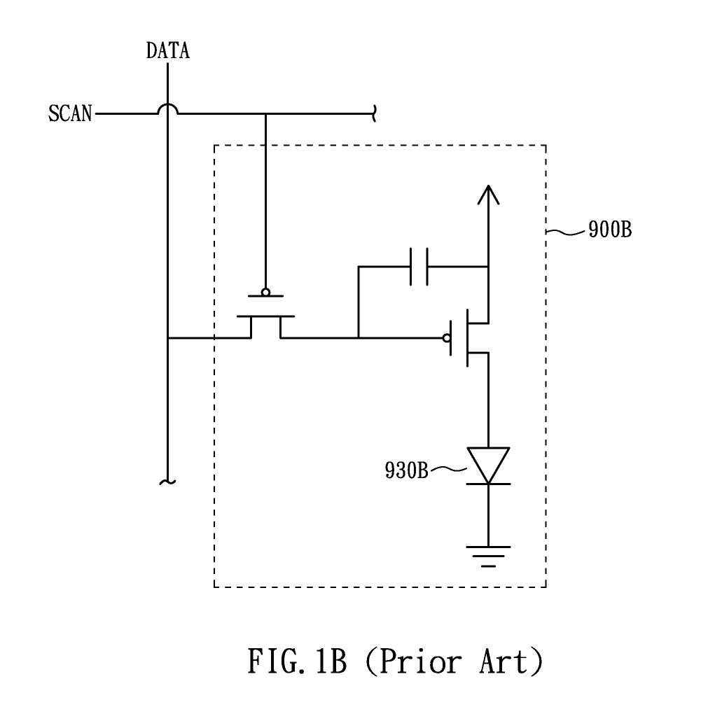

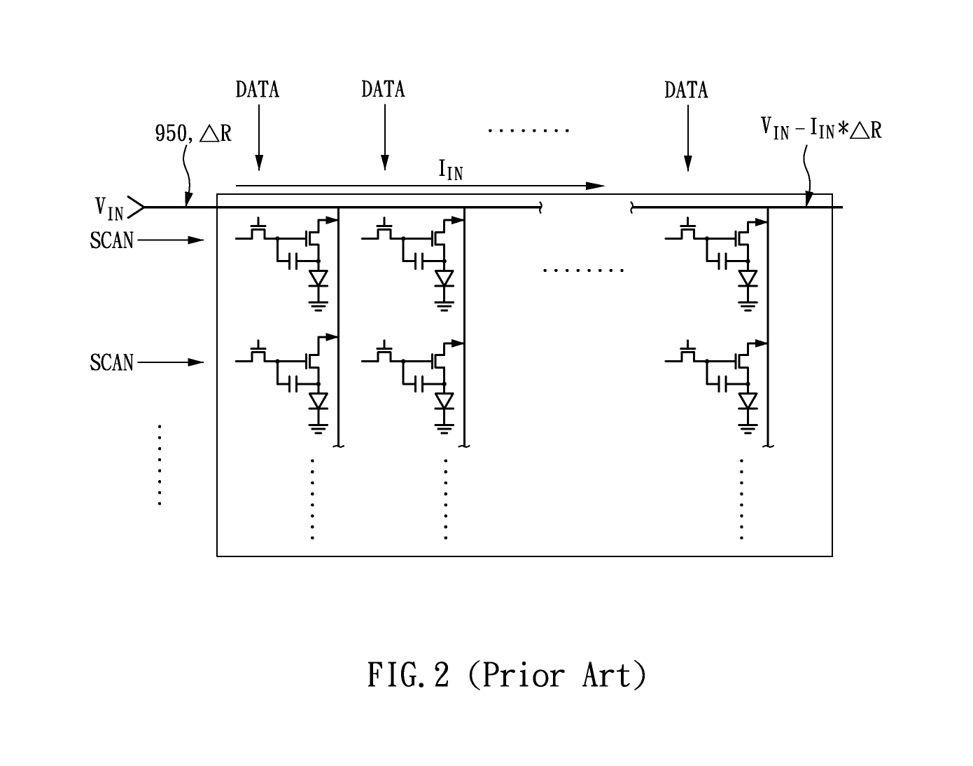

As shown in FIGS. 1B and 7D, compare the TFT 910A with the driving switch 110, the cross voltage between the first node A and the second node B for the driving switch 110 to work in the saturation region may be modulated, so that the driving current ID may not attenuate as time goes by. Furthermore, the driving current ID is not related to the threshold voltage Vt of the driving switch 110 and the second voltage VSS, so that the IR-drop issue may be resolved. Moreover, the OLED 160 may attenuate because of working for a long time and then may cause the rising cross voltage, that may further cause an issue of the cross voltage between the first node A of the driving switch 110 and the driving source. The rising cross voltage issue may be resolved by modulating the cross voltage between the first node A and the second node B.

Although the present invention has been explained in relation to its preferred embodiment, it is to be understood that many other possible modifications and variations can be made without departing from the spirit and scope of the invention as hereinafter claimed.

What is claimed is:

1. A pixel driving circuit of an active-matrix organic light-emitting diode (AMOLED) comprising:
a driving switch having a first node and adapted to receive a first voltage from the power supply unit;
an organic light-emitting diode (OLED) having a second node and a third node that is adapted to receive a second voltage from the power supply unit;
a voltage compensation switch that is electrically connected between said driving switch and said second node, and that is capable of receiving a compensation signal for enabling said voltage compensation switch to perform a compensation on a voltage level between said first node and said second node to equal a threshold voltage of said driving switch;
a storage capacitor electrically connected between said first node and said second node;
a data input switch electrically connected to said first node and capable of receiving a scan signal and a data signal that may be transmitted to said storage capacitor upon said data input switch receiving said scan signal;
a reset unit electrically connected to a first node and capable of receiving a reference voltage, said reset unit may be enabled by a reset signal so as to perform a reset action for modulating a voltage level on said first node to equal said reference voltage; and
a precharge unit electrically connected to said second node and capable of receiving a precharge voltage, said precharge unit may be enabled by a precharge signal to perform a precharge action for modulating a voltage level on said second node to equal said precharge voltage;
wherein said pixel driving circuit may work in a precharge state, a compensation state, a data input state and an light emitting state; said pixel driving circuit is capable of receiving said reset signal and said precharge signal when the pixel driving circuit works in said precharge state, said pixel driving circuit is capable of receiving said reset signal and said compensation signal when the pixel driving circuit works in said compensation state, said pixel driving circuit is capable of receiving said scan data when the pixel driving circuit works in said data input state, said pixel driving circuit is capable of receiving said compensation signal when the pixel driving circuit works in said light emitting state.

2. The pixel driving circuit as claimed in claim 1, wherein said pixel driving circuit works sequentially in an order of said precharge state, said compensation state, said data input state, and said light emitting state in cycles.

3. The pixel driving circuit as claimed in claim 1, wherein said driving switch, said voltage compensation switch, said reset unit, said precharge unit, and said data input switch are each a N-type transistor.

4. The pixel driving circuit as claimed in claim 3, wherein said driving switch has a driving gate, a driving drain and a driving source, said voltage compensation switch has a compensation gate, a compensation drain and a compensation source, said data input switch has a data input gate, a data input drain and a data input source, said driving drain is adapted to receive the first voltage from the power supply unit, said driving gate is integrated with said first node that is electrically connected to said data input source, said driving source electrically is connected to said compensation drain, said data input gate is capable of receiving said scan signal, said data input drain is capable of receiving said data signal, said compensation gate is capable of receiving said compensation signal, and said compensation source is electrically connected to said second node.

5. The pixel driving circuit as claimed in claim 4, further comprising a compensation capacitor electrically connected between said driving drain and said second node.

6. A method of driving a pixel driving circuit of an active-matrix organic light-emitting diode (AMOLED) wherein the pixel driving circuit includes a driving switch having a first node, an organic light-emitting diode (OLED) having a second node and a third node, a voltage compensation switch electrically connected between the driving switch and the second node, a storage capacitor electrically connected between the first and second nodes, a data input switch electrically connected to the first node and capable of receiving a data signal, a reset unit electrically connected to the first node and capable of receiving a reference voltage, and a precharge unit electrically connected to the second node and capable of receiving a precharge voltage, said method comprising the steps of:
(A) the reset unit receiving a reset signal and the precharge unit receiving a precharge signal when the pixel driving circuit works in a precharge state;
(B) the reset unit receiving a reset signal and the voltage compensation switch receiving a compensation signal when the pixel driving circuit works in a compensation state;
(C) the data input switch receiving a scan signal when the pixel driving circuit works in a data input state; and
(D) the voltage compensation switch receiving the compensation signal when the pixel driving circuit works in an light emitting state.

7. The method of driving a pixel driving circuit of an AMOLED as claimed in claim 6, wherein step (A) is configured for enabling the first node to receive the reference voltage and enabling the second node to receive the precharge voltage.

8. The method of driving a pixel driving circuit of an AMOLED as claimed in claim 6, wherein step (B) is configured for modulating a voltage level between the first and second nodes to equal a threshold voltage of the driving switch.

9. The method of driving a pixel driving circuit of an AMOLED as claimed in claim 6, wherein step (C) is configured for enabling the storage capacitor to receive the data signal.

10. The method of driving a pixel driving circuit of an AMOLED as claimed in claim 6, wherein step (D) is configured for enabling the OLED to be driven according to the data signal.

11. A pixel driving circuit of an active-matrix organic light-emitting diode (AMOLED) comprising:
a driving switch having a first node and adapted to receive a first voltage;
an organic light-emitting diode (OLED) having a second node and a third node that is adapted to receive a second voltage;
a voltage compensation switch that is electrically connected between said driving switch and said second node, and that is capable of receiving a compensation signal for enabling said voltage compensation switch to perform a compensation on a voltage level between said first node and said second node to equal a threshold voltage of said driving switch;
a storage capacitor electrically connected between said first node and said second node;
a data input switch electrically connected to said first node and capable of receiving a scan signal and a data signal that may be transmitted to said storage capacitor upon said data input switch receiving said scan signal;
a reset unit electrically connected to a first node and capable of receiving a reference voltage, said reset unit may be enabled by a reset signal so as to perform a reset action for modulating a voltage level on said first node to equal said reference voltage; and
a precharge unit electrically connected to said second node and capable of receiving a precharge voltage, said precharge unit may be enabled by a precharge signal to perform a precharge action for modulating a voltage level on said second node to equal said precharge voltage;
a power supply unit supplying said first voltage to said driving switch and said second voltage to third node;
wherein said driving switch and said compensation switch connected in series;
wherein said pixel driving circuit may work in a precharge state, a compensation state, a data input state and an light emitting state; said pixel driving circuit is capable of receiving said reset signal and said precharge signal when the pixel driving circuit works in said precharge state, said pixel driving circuit is capable of receiving said reset signal and said compensation signal when the pixel driving circuit works in said compensation state, said pixel driving circuit is capable of receiving said scan data when the pixel driving circuit works in said data input state, said pixel driving circuit is capable of receiving said compensation signal when the pixel driving circuit works in said light emitting state.

12. The pixel driving circuit as claimed in claim 11, wherein said pixel driving circuit works sequentially in an order of said precharge state, said compensation state, said data input state, and said light emitting state in cycles.

13. The pixel driving circuit as claimed in claim 11, wherein said driving switch, said voltage compensation switch, said reset unit, said precharge unit, and said data input switch are each a N-type transistor.

14. The pixel driving circuit as claimed in claim 13, wherein said driving switch has a driving gate, a driving drain and a driving source, said voltage compensation switch has a compensation gate, a compensation drain and a compensation source, said data input switch has a data input gate, a data input drain and a data input source, said driving drain is adapted to receive the first voltage from the power supply unit, said driving gate is integrated with said first node that is electrically connected to said data input source, said driving source electrically is connected to said compensation drain, said data input gate is capable of receiving said scan signal, said data input drain is capable of receiving said data signal, said compensation gate is capable of receiving said compensation signal, and said compensation source is electrically connected to said second node.

15. The pixel driving circuit as claimed in claim 14, further comprising a compensation capacitor electrically connected between said driving drain and said second node.
